(19) United States
(12) Patent Application Publication
(10) Pub. No.: US 2010/0133078 A1
(43) Pub. Date: Jun. 3, 2010

(54) INSTALLATION SWITCHING DEVICE

(75) Inventors: Joachim Majewski, Dossenheim (DE); Erwin Muders, Heidelberg (DE)

Correspondence Address: Darby & Darby, P.O. Box 770, Church Street Station, New York, NY, 10008-0770, US

(73) Assignee: ABB AG, Ladenburg (DE)

(21) Appl. No.: 12/598,013

(22) PCT Filed: Apr. 25, 2008
(86) PCT No.: PCT/EP2008/003346

§ 371 Date: Oct. 28, 2009

(30) Foreign Application Priority Data
Apr. 28, 2007 (DE) 10 2007 020 105.4
Apr. 25, 2008 (DE) 10 2008 021 026.9

(51) Int. Cl. H01H 9/02

(52) U.S. Cl. 200/293

(57) ABSTRACT

An installation switching device having an insulating material housing with a front face and an attachment face connected by two broad faces and an input and an output narrow face; an input terminal; an output terminal, wherein a current path runs from the input terminal to the output terminal; a switching mechanism configured to open or close a main contact point so as to switch the current path off and on, respectively, the switching mechanism having a switching handle configured to operate the switching mechanism; and at least one phase connecting rail disposed in an interior of the housing close to and parallel to the attachment face and electrically and mechanically isolated from other components and assemblies in the housing.

The invention relates to an installation switching device as claimed in the precharacterizing clause of claim 1, and to a meter station having an installation switching device as claimed in claim 7.

Installation switching devices of this generic type are known, for example, from DE 195 26 592 C2 or DE 10 2004 019 175 A1. By way of example, they are designed and used as so-called main line circuit breakers. A main line circuit breaker is installed, for example, in the meter station or the installation distribution block of a building electrical installation system. In this case, by way of example, three-phase installation distribution blocks are normally provided, in which three phase rails, which are located one above the other parallel on the attachment plane, and are also referred to as busbars or conductor rails, for the three phases of an electricity supply system which is nowadays generally referred to in the standard manner in the German system as L1, L2, L3, and a phase rail for the neutral conductor is also provided. The installation can in this case be designed such that the appliance is mechanically mounted on a standard profile mounting rail by means of a quick-release attachment apparatus, which is provided on the appliance housing. The appliance is electrically connected to the phase rails via connecting conductors or conductor rails which are introduced into the connecting terminals of the appliance and have appropriate connecting lugs. The electricity is supplied to the phase rails via feed terminals which require additional space in the installation distribution block.

DE 103 35 496 A1 discloses the fitting of an installation switching device in a three-phase installation distribution block via a holding adapter, with the adapter being mechanically and electrically directly mounted on the busbars by means of adapter terminals, and with the electrical connection being made by a busbar within the adapter between the adapter terminal and the connecting terminal of the appliance which is latched onto the adapter. The appliance itself is not suitable for direct mounting on the busbars in an installation distribution block. The holding adapter is an additional component, resulting in the installation being more complex and costing more.

The object of the present invention is therefore to further develop an installation switching device of this generic type such that its mechanical and electrical installation and connection are simpler and its use can be matched in a simple manner to different installation circumstances.

This object is achieved by an installation switching device of this generic type having the characterizing features of claim 1.

Therefore, according to the invention, a phase connecting rail can be arranged in the housing interior close to the attachment face and running approximately parallel to it and, in the installed state, can be connected to the connecting terminal close to the input narrow face and is otherwise electrically and mechanically isolated from the other components and assemblies within the housing, and at whose free end a clamping contact is fitted, which projects out of the housing on the attachment face, for clamping to busbars in an installation distribution block. According to one particularly advantageous embodiment, the housing of the installation switching device has latching means, by means of which the installation switching device can be mounted on busbars in an installation distribution block.

The advantage of an installation switching device according to the invention is that it is mechanically attached to the busbars of the installation distribution block and in this case at the same time makes electrical contact directly, and without the interposition of an adapter, with the busbars of an installation distribution block via the phase connecting rail, which is provided in the housing interior, and by means of the terminal contact located thereon.

In a further particularly advantageous embodiment of the invention, the installation switching device is designed such that phase connecting rails of different length can be arranged, with the length of the phase connecting rail corresponding to the position of the busbar to be connected, with respect to the connecting terminal, when the installation switching device is in the installed state. An installation switching device according to the invention such as this can be modified simply by changing the phase connecting rail which is inserted into an appliance for direct mounting on the L1 phase, the L2 phases or the L3 phase. The phases L1, L2, L3 are located at a defined distance from one another on the mounting plane in the installation distribution block. For example, if it is intended to connect the appliance to phase L1, then the phase connecting rail is chosen to be sufficiently long that its contact terminal emerges from that housing opening which corresponds to the phase L1 when the appliance is in the installed state.

With regard to the connection option to differently located busbars within the installation distribution block, the length of the phase connecting rail is the only variable in an installation switching device according to the invention. All the other components or assemblies within the appliance and their respective position with respect to one another are independent of whether the appliance is intended for connection to the L1 phase, the L2 phase or the L3 phase.

This major advantage is achieved by the refinement according to the invention, in that the phase connecting rail can be connected to the input terminal only in the vicinity of the connection-narrow face and otherwise runs parallel to the inner attachment face of the installation switching device independently and mechanically and electrically isolated from the other components in the interior of the appliance. The only connecting point to the components of the installation switching device is now the input terminal, both for an external connecting conductor and for the internal phase connecting rail. In particular, no connecting point for the internal phase connecting rail is provided at the current path between the two connecting terminals of the installation switching device. The connecting point of both an external connecting conductor and of the internal phase connecting rail is removed from the current path, and is concentrated in the input terminal.

For installation in an installation distribution block having at least three busbars, an embodiment of the invention is highly advantageous in which the insulating material housing has at least three openings on the attachment face for contact terminals to pass through from phase connecting rails which can be arranged in the housing, with the openings corresponding to the position of the three busbars in a three-phase installation distribution block when the installation switching device is inserted into the installation distribution block, and with openings which are not required for contact terminals to pass through being closed by removable covers. From the housing point of view, the appliance is ready for connection to each of the three phase rails.

Installation switching devices according to the invention therefore now require only one type of housing, irrespective of which of the three busbars within the installation distribution block they are intended to be connected to. All three housing openings, which are associated with the respective busbars in the installation position of the appliance, are already provided, and they are covered by means of removable cover plates at the start of appliance manufacture. Once it is known which of the three busbars the appliance is intended to be connected to, then the housing opening which corresponds with this busbar is opened by removing, for example by knocking out, the appropriate cover plate, and a phase connecting rail of suitable length is inserted. If the appliance is intended to be subsequently connected to another busbar, then the previous opening is closed by refitting the cover plate, the opening in the housing which corresponds to the position of the other busbars is opened, the originally inserted phase connecting rail is removed, and a phase connecting rail is inserted whose length now corresponds to the position of the other busbar.

According to a further advantageous embodiment, an installation switching device according to the invention can also be designed for attachment by means of a busbar adapter to the busbars of an installation distribution block or by means of a quick-release attachment apparatus to a standard profile mounting rail, when the phase connecting rail which can be arranged is removed, and the housing is appropriately matched for attachment by means of a busbar adapter to the busbars of an installation distribution block or by means of a quick-release attachment apparatus to a standard profile mounting rail. Simple removal of the phase connecting rail converts the installation switching device according to the invention to a conventional installation switching device which can be mounted in a conventionally known manner, for example by means of an adapter, on the busbars of an installation distribution block. An installation switching device according to the invention can therefore be used in a highly flexible manner. Without modifying the housing and without modifying the internal design, the adaptation is carried out, irrespective of whether the appliance is intended to be mounted directly or by means of an adapter on the busbars of an installation distribution block, simply by choosing whether or not a phase connecting rail is intended to be used on the housing inner face on the attachment face.

The electricity can therefore be supplied to the appliance in two ways. If the busbar to which the appliance is clamped is live, then the electricity is supplied via the terminal contact and the phase connecting rail. If the busbar is not live, then the electricity is supplied via a connecting conductor to the input terminal which is screwed on there, for example, in a known manner.

This form of feed to the appliance via a connecting conductor opens up a further advantage of the invention. Furthermore, the electricity can be fed into the busbar of the installation distribution block via the phase connecting rail and the terminal contact. The installation switching device then carries out a dual function. It acts as a main line circuit breaker for the downstream circuits, and at the same time as a feed terminal for the busbar to which it is attached, thus allowing electricity to be supplied to other appliances which are connected to the same busbar. There is therefore no need for any separate feed terminal, and space is saved in the installation distribution block.

The integrated phase connecting rail can highly advantageously also be used when the installation switching device is used in a photovoltaic installation for protection of the electricity feed from the inverter of the photovoltaic installation to the electrical power supply system. The current which is produced in the photovoltaic module and is converted in the inverter to an AC voltage then flows via the output terminal into the installation switching device according to the invention, and leaves it at the input terminal. From there, the current path can be led further via a connecting conductor, or the electricity can be fed into the busbar system via the integrated phase connecting rail and can be distributed further from there, and this is all done without having to make any change or modification to the installation switching device.

Further advantageous refinements and improvements of the invention, and further advantages, can be found in the dependent claims.

The invention and further advantageous refinements and improvements of the invention will be explained and described in more detail with reference to the drawings, which illustrate three exemplary embodiments of the invention, and in which:

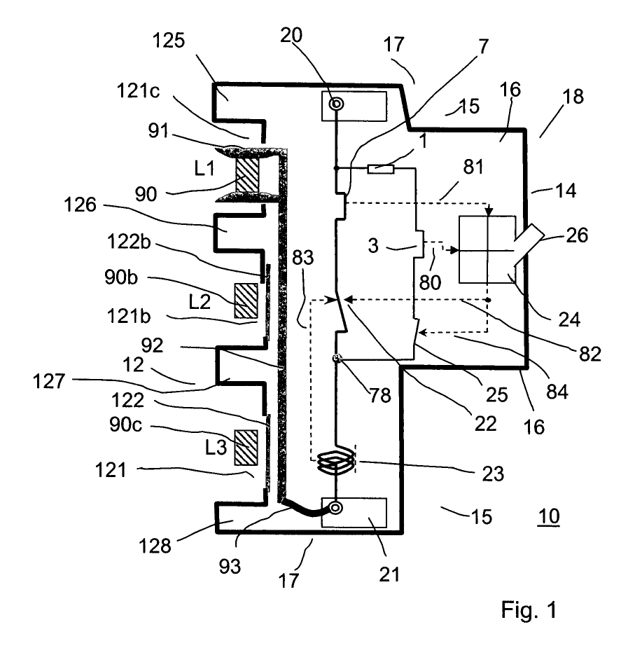

FIG. 1 shows an installation switching device according to the invention in the form of a selective main line circuit breaker, for direct connection to the phase rail L1,

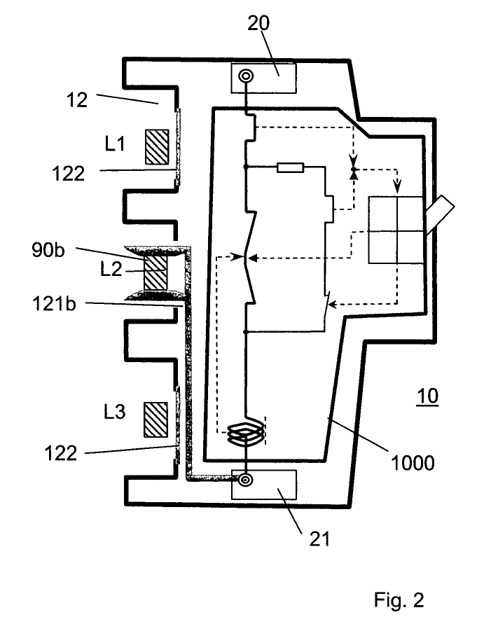

FIG. 2 shows an installation switching device according to the invention in the form of a selective main line circuit breaker, for direct connection to the phase rail L2,

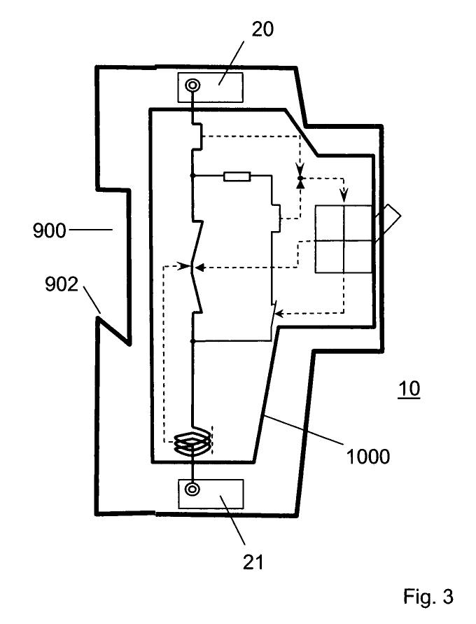

FIG. 3 shows an installation switching device according to the invention in the form of a selective main line circuit breaker, for mounting on a standard profile mounting rail, with the internal design otherwise being unchanged in comparison with the embodiments shown in FIGS. 1 and 2,

FIG. 4 shows a detailed view into an installation switching device according to the invention as shown in FIG. 1, and

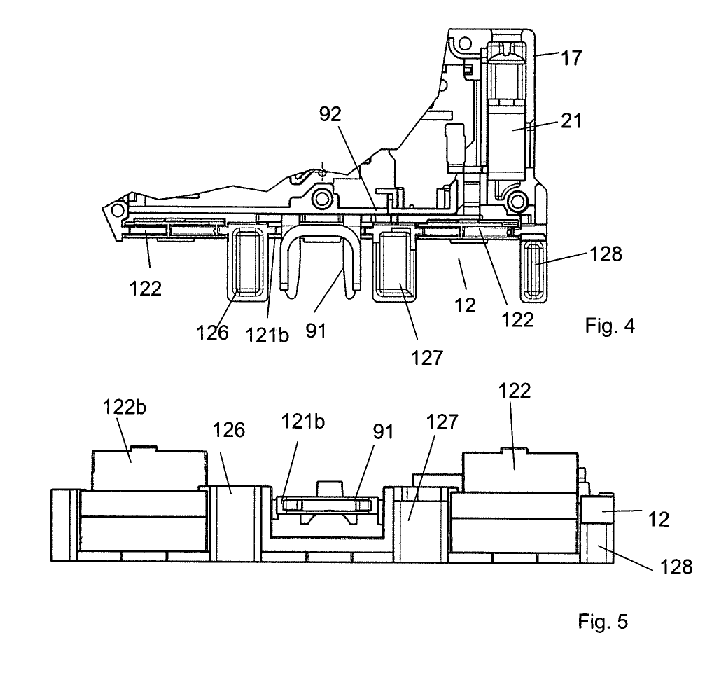

FIG. 5 shows a view of the attachment face of an installation switching device according to the invention.

Components or assemblies which are the same or have the same effect are annotated with the same reference numbers in the figures.

FIG. 1 will be considered first of all. This shows the circuit layout of an installation switching device according to the invention, fitted into the circumferential contour of the housing.

A main current path, which also passes through a main thermostatic bimetallic strip 7, a main contact point 22 and an impact-type armature system 23, runs between an input terminal 21 and an output terminal 20. A secondary current path runs in parallel with the series circuit comprising the main current bimetallic strip 7 and the main contact point 22. This secondary current path comprises a current limiting resistor 1, a selective thermostatic bimetallic strip 3 and an isolating contact point 25.

The main contact point 22 is designed for single interruption. It comprises a moving contact lever 221, which is fitted with a moving contact piece, and a stationary contact point 222 with a stationary contact piece. The moving contact lever 221 is mounted on a shaft which is fitted in a fixed position in the housing.

Furthermore, a mechanical latching mechanism 24 is included in the installation switching device. This is mechanically operatively connected on the one hand to the main thermostatic bimetallic strip 7 and the selective thermostatic bimetallic strip 3 along lines of action 81, 80, and on the other hand the latching mechanism 24 is mechanically operatively connected along lines of action 82, 84, 86 to the isolating contact point 25 and the main contact point 22.

The installation switching device according to the invention and according to the circuit layout shown in FIG. 1 operates as follows. When a short-circuit current occurs in the main current path, the impact-type armature system 23 knocks the moving contact lever 221 very quickly away from the stationary contact piece along the line of action 83, and thus opens the main current path at the main contact point 22. During this switching operation, a switching arc is struck at the main contact point 22, is supplied to an arc quenching arrangement, which is associated with the main contact point 22, and is quenched therein.

When the main contact point 22 is opened, the current profile commutates onto the secondary current path. The short-circuit current now flows through the current limiting resistor 1, the selective thermostatic bimetallic strip 3 and the isolating contact point 25 to the connection point 78 where the main current path and the secondary current path are connected together. After a specific delay time, which can be predetermined inter alia by the choice of the resistance value of the current limiting resistor 1, the limited short-circuit current in the secondary current path results in the selective thermostatic bimetallic strip 3 acting along the line of action 80 on the latching mechanism 24 such that it permanently opens the isolating contact point 25 along the line of action 82, 84, and permanently opens the main contact point 22 along the line of action 86. An arc is likewise struck during this switching operation, is supplied to a further arc quenching device, which is associated with the isolating contact point 25, and is quenched therein. Both the main contact point and the isolating contact point have now been interrupted, and the current flow through the appliance has therefore been interrupted completely. Reconnection can now be carried out manually by operation of the latching mechanism 24 via a handle 26.

A phase connecting rail 92 is connected to the access terminal 21, also referred to as the input terminal, via a flexible coupling braid 93. At its free end, a phase connecting rail 92 has a terminal contact 91, by means of which it can be clamped to a phase rail 90, also referred to as a busbar, in an installation distribution box, when the installation switching device is fitted there. The installation switching device according to the invention can thus be mechanically and electrically attached, and electrically connected, directly and without the interposition of an adapter and without requiring any feed terminal, via the phase connecting rail 92 to the phase rails 90, which are also referred to as busbars, in an installation distribution block.

The installation switching device 10 has an insulating material housing 18 which has a forward front face 14, rearward front faces 15, an attachment face 12 and forward and rearward narrow faces 16, 17. The forward narrow faces 16 connect the forward front face 14 to the rearward front faces 15. The rearward narrow faces 17 connect the rearward front faces 15 to the attachment face 12. The housing 18 is therefore approximately in the form of an inverted T, with the longitudinal bar of the T being bounded by the forward narrow faces 16 and the forward front face 14, and with the latching mechanism 24, the isolating contact 25 and the selective bimetallic strip 3 being arranged in the area of this longitudinal bar. The main thermostatic bimetallic strip 7, the main contact point 22, the impact-type armature system 23, the arc quenching device (not illustrated here) and the current limiting resistor 1 are arranged in the lateral bar of the T-shaped housing, which is bounded by the rearward narrow faces, the rearward front face and the attachment face.

Three phase connecting openings 121, 121b, 121c are incorporated in the attachment face 12 of the installation switching device. The phase connecting openings 121, 121b, 121c are positioned such that they correspond with the position of three conductor rails or busbars 90, 90b, 90c, also referred to as L1, L2, L3, in an installation distribution block, when the installation switching device is fitted in the installation distribution block. The phase connecting rail 92 runs parallel to the attachment face 12 in the interior of the housing 18. The position of the phase connecting opening 121c corresponds, in terms of size and orientation, to the terminal contact 91 which is fitted to the free end of the phase connecting rail 92, such that the terminal contact 91 passes through the phase connecting opening 121c and can interact with the busbar 90, L1, in a clamping manner. The terminal contact 91 is in the form of a spring terminal contact with two mutually opposite sprung terminal strips. The two other phase connecting openings 121, 121b are covered by cover parts 122, 122b, in such a way that no contamination can enter the appliance interior at these points.

The appliance shown in FIG. 1 is therefore designed for connection to the outer ones of the three busbars of an installation distribution block. When an appliance variant is required for connection to the central one of the three busbars L2, then the phase connecting rail 92 is replaced by another, shorter phase connecting rail, whose terminal contact, when in the installed state on the central phase connecting opening 122b, projects out of the attachment face 12. In this case, the two other phase connecting openings 121, 121c can then be closed by corresponding cover plates. This configuration is illustrated in FIG. 2, in which the components of the internal circuitry of the switching device are also indicated schematically and jointly by the box 1000.

Projections 125, 126, 127, 128 are integrally formed on the attachment face 12, between the phase connecting openings. The housing can be mechanically supported by means of these projections 125, 126, 127, 128 on the other busbars, which are not electrically connected. In particular, the upper and the lower projections 125, 128 can be replaced by a respective latching apparatus, for example a latching hook, by means of which the appliance can be latched onto busbars in the installation distribution block. Latching apparatuses such as these are known, for example from DE 103 35 496 A1, in particular in FIG. 8, whose disclosure is intended to be included here in this context.

The installation switching device according to the invention therefore makes it possible to produce appliances for connection to different busbars without any other modifications to the position of the internal functional components, simply by use of a phase connecting rail of suitable length and opening the corresponding phase connecting opening, and closing the other phase connecting openings, which are not required, by a cover plate. No further connecting means are required for connecting an appliance according to the invention with busbars. This therefore ensures a high degree of flexibility for modular internal design of the appliance.

In the case of an appliance according to the invention, it is, of course, also possible to connect an access conductor to the access terminal 21 in a known manner, for example by screwing it on by means of a screw terminal. This connection option may be used when the switching device according to the invention is installed at an installation location where there are no phase rails or busbars, or in which the busbar does not have current applied to it by a busbar terminal.

Finally, because of the phase connecting rail 92 according to the invention, which is electrically connected to the access terminal 21 in the housing interior, a switching device according to the invention also allows an application in which the current flow is supplied to the main current path via a conductor which is connected to the access terminal 21, and a busbar, to which the appliance is attached, is simultaneously supplied with current via the phase connecting rail 92, such that the installation switching device according to the invention also carries out the function of a phase connecting terminal to a busbar, in addition to its function as an automatic protective device.

When three installation switching devices according to the invention are arranged in a row and are installed in an installation distribution block or a meter station with a three-phase busbar system, then each of the three appliances is provided with a phase connecting rail which is prepared for connection to a different busbar.

Because of the double capability for electrical connection, either via the access terminal 21 by means of a connecting conductor or via the phase connecting rail 92 by means of a busbar in an installation distribution block, an installation switching device according to the invention opens up a wide range of applications without any modifications in the appliance having to be made for different connection variants.

The selective main line circuit breaker is modified such that it can be used for feeding the busbar system or for outputting from the busbar system at the same time.

In a typical installation system, the feed conductor is passed from the building connecting protective device to the connecting terminal 21 of the appliance 10. The appliance supplies the busbar 90 with the feed voltage via the internal phase connecting rail 92. An overall feed of 125 A is possible. There is no need to provide a separate busbar terminal for feeding the feed voltage to the busbar.

However, it is also possible to supply the busbar 90 in a known manner via a busbar terminal, and to feed further additional appliances, which are not connected to the busbar, via a connecting conductor at the connecting terminal of the installation switching device 10. This avoids the need to provide further busbar terminals for feeding additional appliances on the busbar.

The space which is saved in this way in the building connecting box can be used with other functional components, for example a surge arrestor.

In the case of an installation for electricity generation by means of solar cells, also referred to as photovoltaic elements or a photovoltaic system, direct current is produced in the photovoltaic elements, and is converted to alternating current by means of an inverter. The alternating current generated in this way can then be fed via its own electricity meter into the public electricity mains system. An installation switching device according to the invention, and as shown in FIGS. 1 and 2, can likewise be used to protect this mains system feed. The electricity is supplied in this application at the output terminal 20, and the current path leaves the appliance at the input terminal 21. The electricity can then be passed on to the public electricity mains system either via a connecting conductor, which is connected to the input terminal 21, or the electricity is fed into the busbar system via the phase connecting rail 92, and is supplied from there to the public electricity mains system.

The housing design of appliances as shown in FIGS. 1 and 2 is suitable for direct mounting on the busbars of an installation system. However, if an appliance according to the invention is intended to be mechanically attached to a standard profile mounting rail, for example a top-hat profile mounting rail, then the appliance requires a corresponding quick-release attachment apparatus on its attachment face, which is designed for mounting on standard profile mounting rails. An appliance according to the invention and as shown in FIGS. 1 and 2 can therefore easily be converted to an appliance which is suitable for mounting on standard profile mounting rails, by installing the internal components and assemblies in a housing as shown in FIG. 3. The internal design of the appliance, the position and mutual arrangement of all the internal components and assemblies, are unchanged in this case.

The difference from the embodiment shown in FIGS. 1 and 2 is that a snap-in apparatus for the standard profile mounting rail is integrally formed on the attachment face, in the form of a recess with a holding tab 902, which is designed to interact in a latching manner with the standard profile mounting rail. The phase connecting rail 92 is not needed, and the chamber provided to accommodate it on the inside of the attachment face 12 remains empty. The appliance is electrically connected by connecting a connecting conductor to the input terminal 21. In addition, a sprung quick-release attachment apparatus can also be fitted to the recess 900. Quick-release attachments such as these are known in principle, for example from DE 10 2004 019 173 A1.

FIG. 4 shows one embodiment as a detail view into one specific design configuration of an installation switching device according to the invention, as shown in FIG. 1. FIG. 5 shows a view of the attachment face of an installation switching device according to the invention as shown in FIG. 4. The reference signs in this case denote the parts and components which have already been mentioned in the description relating to FIGS. 1 and 2.

### LIST OF REFERENCE SYMBOLS

1 Current limiting resistor
3 Selective thermostatic bimetallic strip
7 Main thermostatic bimetallic strip
10 Selective circuit breaker, installation switching device
12 Attachment face
14 Forward front face
15 Rearward front face
16 Forward narrow face
17 Rearward narrow face
18 Housing
20 Output terminal
21 Input terminal, access terminal
22 Main contact point
23 Impact-type armature system
24 Latching mechanism
25 Isolating contact point
26 Handle
78 Connection point
80 Line of action
81 Line of action
82 Line of action
83 Line of action
90 Phase rail, busbar, conductor rail
90b Phase rail, busbar, conductor rail
90c Phase rail, busbar, conductor rail
91 Terminal contact
92 Conductor rail, phase connecting rail
93 Flexible braid
121 Phase connecting opening
121b Phase connecting opening
121c Phase connecting opening
122 Cover
122b Cover
125 Projection
126 Projection
127 Projection
128 Projection
1000 Box

1-7. (canceled)

8. An installation switching device comprising:
an insulating material housing having a front face and an attachment face connected by two broad faces and an input and an output narrow face;
an input terminal;
an output terminal, wherein a current path runs from the input terminal to the output terminal;
a switching mechanism configured to open or close a main contact point so as to switch the current path off and on, respectively, the switching mechanism having a switching handle configured to operate the switching mechanism; and
at least one phase connecting rail disposed in an interior of the housing close to and parallel to the attachment face and electrically and mechanically isolated from other components and assemblies in the housing, the phase connecting rail including a free end and a clamping contact disposed at the free end, the clamping contact projecting out of the housing on the attachment face and configured to clamp a busbar in an installation distribution block, wherein the phase connecting rail is connectable to the input terminal in an installed state.

9. The installation switching device as recited in claim 8, wherein the housing includes a latching device configured to attach the installation switching device to at least one busbar in an installation distribution block.

10. The installation switching device as recited in claim 9, wherein the at least one phase connecting rail includes a plurality of phase connecting rails each having a different length, wherein the length of each of the plurality of phase connecting rails corresponds to a position of each of a plurality of busbars to be connected with respect to the input terminal when the installation switching device is in the installed state.

11. The installation switching device as recited in claim 10, wherein the housing includes at least three openings disposed on the attachment face, each opening for receiving a contact terminal disposed in the housing from each of the plurality of phase connecting rails, wherein each of the at least three openings corresponds to a position of at least three busbars in a three-phase installation distribution block when the installation switching device is disposed in the installation distribution block, and further comprising at least one removable cover closing one of the at least three openings not having a contact terminal.

12. An installation switching device comprising:
an insulating material housing having a front face and an attachment face connected by two broad faces and an input and an output narrow face;
an input terminal;
an output terminal, wherein a current path runs from the input terminal to the output terminal; and
a switching mechanism configured to open or close a main contact point so as to switch the current path off and on, respectively, the switching mechanism having a switching handle configured to operate the switching mechanism, and wherein the housing is matched for attachment by one of a busbar adapter to a plurality of busbars of an installation distribution block and a quick-release attachment apparatus to a standard profile mounting rail.

13. A meter station comprising:
an installation switching device including an insulating material housing having a front face and an attachment face connected by two broad faces and an input and an output narrow face; an input terminal; an output terminal, wherein a current path runs from the input terminal to the output terminal; a switching mechanism configured to open or close a main contact point so as to switch the current path off and on, respectively, the switching mechanism having a switching handle configured to operate the switching mechanism; and at least one phase connecting rail disposed in an interior of the housing close to and parallel to the attachment face and electrically and mechanically isolated from other components and assemblies in the housing, the phase connecting rail including a free end and a clamping contact disposed at the free end, the clamping contact projecting out of the housing on the attachment face and configured to clamp a busbar in an installation distribution block, wherein the phase connecting rail is connectable to the input terminal in an installed state.

14. A photovoltaic installation for electricity generation and for feeding into the electrical mains system comprising:
an installation switching device including an insulating material housing having a front face and an attachment face connected by two broad faces and an input and an output narrow face; an input terminal; an output terminal, wherein a current path runs from the input terminal to the output terminal; a switching mechanism configured to open or close a main contact point so as to switch the current path off and on, respectively, the switching mechanism having a switching handle configured to operate the switching mechanism; and at least one phase connecting rail disposed in an interior of the housing close to and parallel to the attachment face and electrically and mechanically isolated from other components and assemblies in the housing, the phase connecting rail including a free end and a clamping contact disposed at the free end, the clamping contact projecting out of the housing on the attachment face and configured to clamp a busbar in an installation distribution block, wherein the phase connecting rail is connectable to the input terminal in an installed state.
